(19) United States
(12) Patent Application Publication
(10) Pub. No.: US 2009/0114577 A1
(43) Pub. Date: May 7, 2009

(54) FLOW RATE CALIBRATED, MECHANICALLY ADJUSTABLE STORMWATER FLOW DIVERTER

(76) Inventor: Gregory S. Duncan, (US)

Correspondence Address: Gregory S. Duncan, 3009 South Drive, Allentown, PA, 18103, US

(21) Appl. No.: 11/775,180

(22) Filed: Jul. 9, 2007

(51) Int. Cl. B01D 35/157

(52) U.S. Cl. 210/88; 210/137

(57) ABSTRACT

An object of this invention is to provide an improved stormwater diversion device that offers a more precise, easy to install and accurate means for diverting stormwater flow than any of the aforementioned prior art techniques. Referring now to the drawings, a flow rate gauge (1) is displayed on top of the apparatus clearly allows the installer to easily calibrate the device's potential flow rate to fit any particular need/situation without having to change the dimension of the box itself. Quite simply, after the device is fitted to the storm sewer structure, and the structure (e.g. inlet box) is installed in the field; the installer is merely required to use a lug wrench to either accommodate more flow, by turning the adjustment nut (2) counter-clockwise resulting in the movement (opening) of the gate (3) along the track (4) or reduce the allowed flow rate, by turning clockwise resulting in the movement (closure) of the gate (3) along the track (4). While the movement of the gate adjusts the aperture (orifice) size, the gauge (1) will continually allow the installer to observe what flow rate would be achieved depending on the setting of the gate (3). A qualified engineer knowledgeable in hydrological methods would determine the selected flow rate required.

### BACKGROUND OF THE INVENTION

1. Field of the Invention

This invention relates to improvements in stormwater drainage structures (e.g., drainage inlets, manholes and the like), and specifically those that require diversion of a specific amount of stormwater flow.

2. The Prior Art

The reason behind the development of techniques in stormwater flow diversion or “flow-splitting” is as a result of addressing federal (EPA) mandate referred to as the Clean Water Act. Among the many provisions set out by the Clean Water Act, one of the more well known is the preservation of stormwater quality. As a result, over the years, it became commonplace for engineers to devise ways to separate lower flow events within storm sewers for the purposes of treating smaller rainfall events. These smaller events, sometimes known as the “water quality event” are separated from the storm sewer by a diversion structure and then conveyed to a water quality treatment facility. Because it is not practical to divert and treat larger events (high flow events e.g. 10-yr storm event), these high-flow events are not typically diverted and thus, will be conveyed in the typical manner, to a river, creek, or some other waterbody. In review, what is sought out by partial diversion technologies, as it relates to stormwater is the intent of removing smaller rainfall events from the storm sewer network, diverting these lower flows into facilities that provide treatment for water quality purposes.

Currently, stormwater is collected in inlet structures, an engineer qualified in hydrology calculates a certain amount of the overall flow; this is referred to as the “water quality flow” (this can sometimes be referred to as a “first flush” event). The basic principal here is that this is the part of the storm containing the majority of the turbid, or dirty, debris laden, stormwater and should be separated and treated in some way, typically, a water quality “facility”. The Environmental Protection Agency (EPA) refers to these “facilities” as “best management practices” or BMPs.

Water Quality treatment for stormwater can be attained though a variety of means, preferred methods vary from state to state. Typical structural methods (BMPs) used for treatment of turbid (dirty) stormwater can be: bio-retention swales, infiltration swales, gravity settling chambers, stormwater filters (see proprietary water quality chambers) to name just a few. That being said, the problem remains to determine an easy to install, shallowly placed, accurate and repeatable method for separating lower storm events, requiring treatment, from the greater (high-flow) storm events. Additionally, the benefit of such a device/system that can be installed to immediately separate the “water quality volume” would be that more discrete BMPs could be utilized along the edge of a roadway. This would eliminate the need to take additional space for larger BMP facility further downstream.

In the past, flow diversion or “flow splitting” has been addressed in a variety of ways. One common approach is to dedicate a structure downstream of a series of stormwater conveyance structures (e.g. inlets, headwalls, manholes), and then utilize a “weir”, which would appear as a partial wall inside the structure. Using this procedure, the “weir” wall prevents water from proceeding to the outlet. The height of the wall is calculated based on the required flow that is to be “diverted”. Quite simply, flow builds up behind the wall and drains only into the diversion orifice/pipe, until the water crests the “weir” (wall) and reaches the outlet, this “cresting” flow represents the flow greater than the water quality storm (event) (see FIGS. 5A & 5B for illustrative example of how this method works while 6A & 6B shows how the invention will vary from the current method). This crude, although widely used method of segregating lower flows typically leads to relatively large BMPs, due to the fact that multiple structures will generally drain to this BMP. The combination of so many drainage areas forces the engineer/designer to plan a relatively large area/space for water quality treatment. Additionally, this introduces increased mixing of the more turbid “first flush” with the subsequent “less dirty” water volume. These traditional diversion structures also tend to be deep, increasing the difficulty of achieving water quality through infiltration (percolating stormwater into the ground), due to high groundwater in many regions.

In conclusion, insofar as I am aware, no current stormwater diversion device/structure formally developed provides an accurate and repeatable, easy to install and field adjustable, diversion apparatus while maintaining/achieving an advantageous/functionally low depth profile.

### SUMMARY OF THE INVENTION

In view of the foregoing discussion, an object of this invention is to provide an improved stormwater diversion device that offers a more precise, easy to install and accurate means for diverting stormwater flow than any of the aforementioned prior art techniques.

Another object of this invention is to provide a stormwater diversion device that can be readily adjusted to achieve a wide range of flow rates.

According to a preferred embodiment of the invention, an improved stormwater diversion apparatus comprising: (a) an adjustment feature that allows for the fine-tuned modulation of an aperture (orifice); (b) this aperture (orifice) being specific to the diversion of stormwater from a structure that the device is mounted in; and (c) a gauging mechanism that directly corresponds the aperture (orifice) setting to a pre-tested flow rate based on the structure's full flow capacity before overflow occurs.

As will be appreciated from the ensuing detailed description of a preferred embodiment, the invention affords the advantages of: 1) modularity (more easily repeatable results and ease of installation), the same type (model) of unit can be placed and adjusted for a wide range of flows 2) accuracy, the flow characteristics of the device is lab tested, which will provide a closer approximation of actual flow rates that will occur in the field; rather than depending on empirically derived equations that will more roughly approximate the expected flow rate. 3) Enhanced water quality; by separating the majority of dirty stormwater before it can enter into the stormwater conveyance network (i.e. the storm sewer), and 4) a more shallow depth profile allowing for easier, more local, separation of the water requiring “treatment” (i.e. diversion to a BMP Facility). See 5A, 5B, 6A & 6B for figures comparing the currently used methods to the newly proposed device.

The invention and its various advantages will become better understood from the ensuing detailed description of preferred embodiments, reference being made on the accompanying drawings in which like reference characters denote like parts.

### BRIEF DESCRIPTION OF THE DRAWINGS

FIG. 1A is a schematic illustration of a stormwater diversion system in which the invention is particularly useful; [apparatus embodying the invention; has been arranged collection of isometric views associated with the installation of the invention: FIG. 1B (top-view), FIG. 1C (side-view). In this incidence the device is shown being installed in an inlet box. Installed in the smaller box, the invention is to be situated upslope of the main box, hence intercepting flow first. The invention is to be fastened to the wall of the inlet box. A knock-out or orifice is to be made in the side of the box to allow a path of the diverted flow;]

FIGS. 2A and 2B are top and front views, respectively, of a preferred embodiment, portions of the apparatus being cut-away to illustrate interior components (FIG. 2C and FIG. 2D): [the invention itself with a view of device's inner-workings;]

FIG. 3 is an enlarged perspective views of a portion of the FIG. 2A apparatus, illustrating the movement of interior components to achieve opening and closing of a diversion gate; and

FIG. 4 is an enlarged view of a flow-rate gauge used in the apparatus of the invention.

FIG. 5A is a side (profile) view of a standard diversion structure constructed in a standard double sized inlet box.

FIG. 5B is a top (plan) view of a standard diversion structure constructed in a standard double sized inlet box.

FIG. 6A is a side (profile) view of invention installed upslope of a standard inlet box.

FIG. 6B is a top (plan) view of invention installed upslope of a standard inlet box.

FIG. 7A is a top (plan) view of invention installed upslope of a standard inlet box. This drawing shows the device installed and placed in a functional field setting and shows a how the device will work, once placed.

FIG. 7B is a side (profile) view of invention installed upslope of a standard inlet box.

FIGS. 8A & 8B depicts a design variation to the device, where the aperture (orifice) is adjusted in a linear fashion. The drawing also indicates with a force being directed against the handle, to slide the aperture (orifice) to the desired opening area. Instead of a gauge, a “ruler-type” scale with graduated flow increments is shown as a means of directing the installer to what gate setting corresponds with the required flow rate needed for diversion. This is to serve as an example of how the same principles/advantages can be achieved with only minor variations the device's make-up.

FIGS. 9A & 9B depicts a design variation to the device, where the aperture (orifice) is adjusted by swapping out plates with different orifice sizes which would vary the flow rate based on the size of the orifice on the plate. This is to serve as an example of how the same principles/advantages can be achieved with only minor variations the device's make-up.

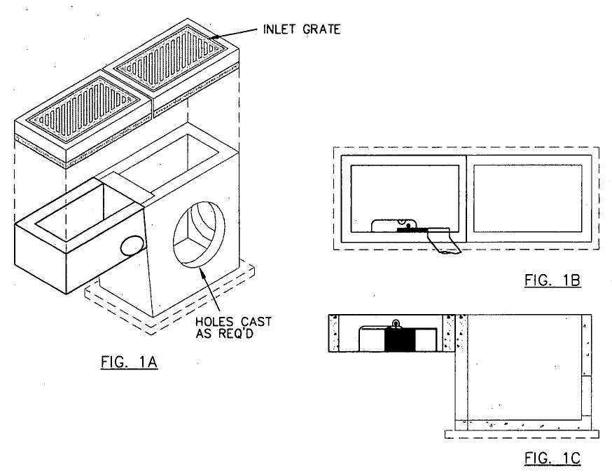

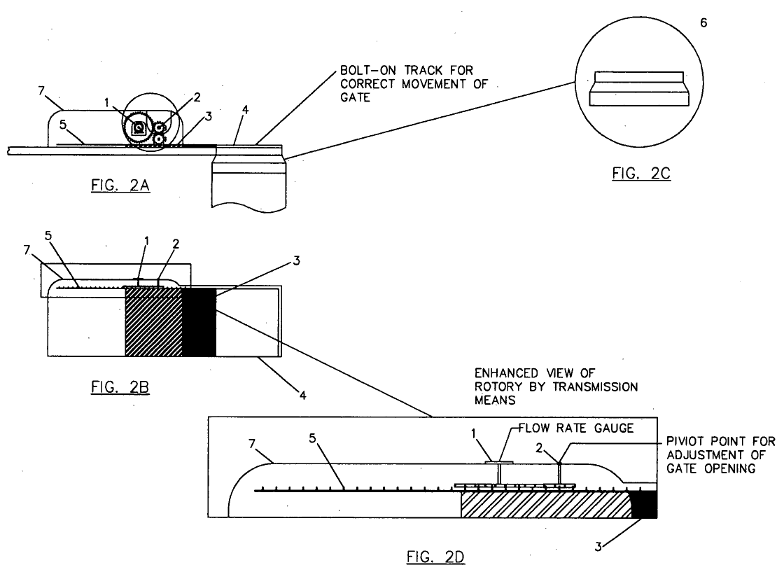

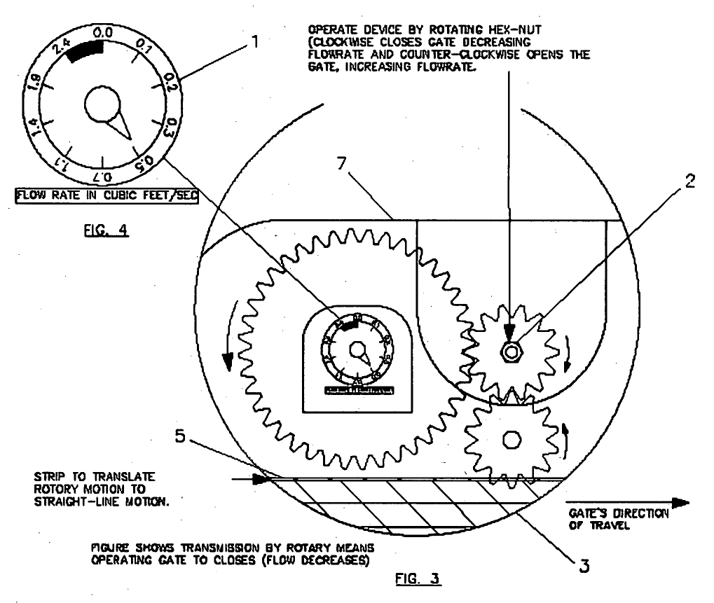

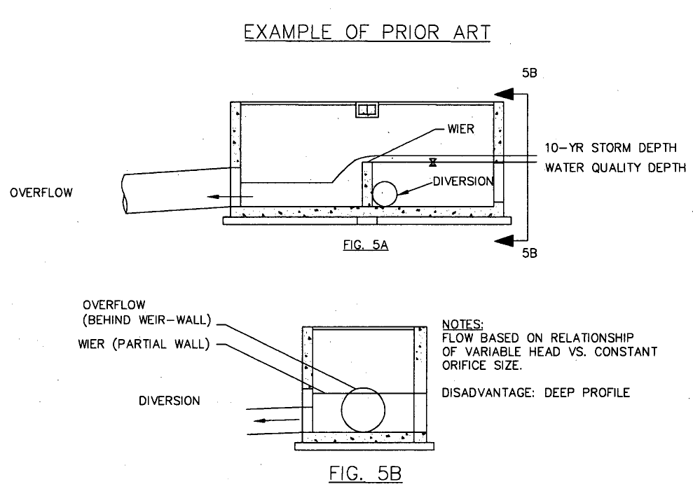

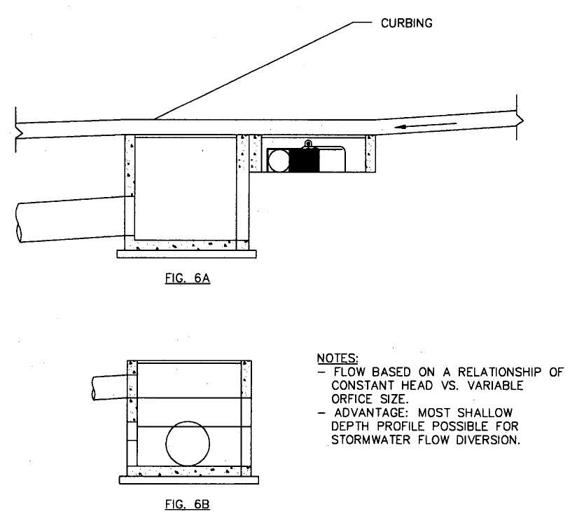

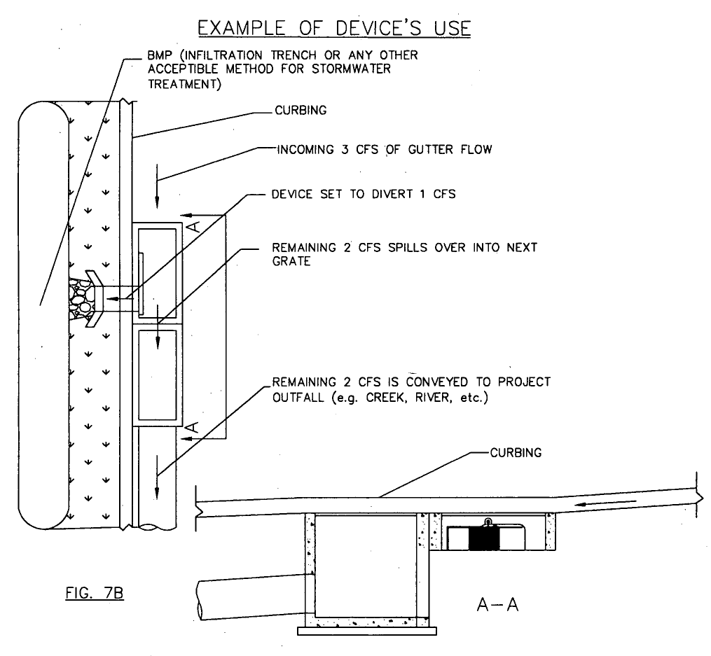

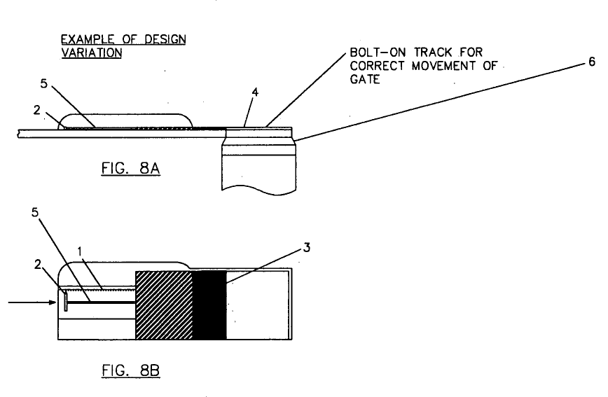

### DRAWING-REFERENCE NUMERALS

1—Flow rate gauge (or graduated flow measuring strip for FIGS. 8A & 8B)

2—Operating nut (or adjustment handle for FIGS. 8A & 8B)

3—Gate

4—Track lined with gasketed seal

5—Toothed strip (or rod) to translate rotary motion to straight-line motion

6—Conduit adapter and coupling link

7—Exterior cowling

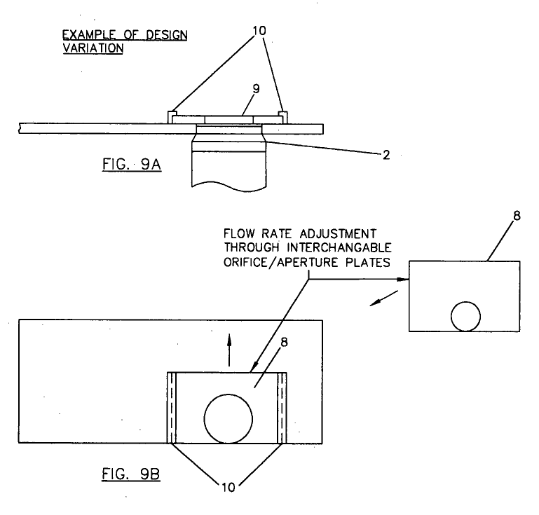

8—Orifice plate (FIG. 9 only, design variation)

9—Orifice cutout (FIG. 9 only, design variation)

10—Orifice plate receiving slots (FIG. 9 only, design variation)

### DETAILED DESCRIPTION OF PREFERRED EMBODIMENTS

Referring now to the drawings, A flow rate gauge (1) is displayed on top of the apparatus clearly allows the installer to easily calibrate the device's potential flow rate to fit any particular need/situation without having to change the dimension of the box itself. Quite simply, after the device is fitted to the storm sewer structure, and the structure (e.g. inlet box) is installed in the field; the installer is merely required to use a tool to either accommodate more flow, by turning the adjustment nut (2) counter-clockwise resulting in the movement (opening) of the gate (3) along the track (4) or reduce the allowed flow rate, by turning clockwise resulting in the movement (closure) of the gate (3) along the track (4). While the movement of the gate adjusts the aperture (orifice) size the gauge (1) will continually allow the installer to observe what maximum flow rate will be achieved depending on what setting the gate (3) is left at. A qualified engineer, knowledgeable in hydrological methods would determine the preset flow rate required.

While the invention has been described with reference to a particularly preferred embodiment, it will be appreciated that various variations and modifications may be made without departing from the spirit of the invention. Such changes are intended to fall within the scope of the appended claims.

### Conclusion, Ramifications, and Scope

Accordingly the reader will see that, according to one embodiment of the invention, I have provided a better, more accurate, more facilitative method of addressing the diversion (or partial diversion) of stormwater (i.e. the shallow depth profile will allow for placement of BMPs that would have otherwise not been feasible, due to depth separation to groundwater/limiting zones required by regulations and township ordinances).

While the above description contains many specificities, these should not be construed as limitations on the scope of any embodiment, but as exemplifications of the presently preferred embodiments thereof. Many other ramifications and variations are possible within the teachings of the various embodiments. For example (not to be considered as an exhaustive listing), if the device was fitted into another type of structure, such as a manhole, or if the overflow conveyance path (e.g. large diameter pipe or a cutout in the side of the structure) is created within the box instead of, as shown, the device's chamber being flooded and thus being allowed to spill into the next inlet grate (this has been done for the purposes of minimizing the installation depth of the structure) in the attached figures, or if a different material is used in for any of the parts, or a different means of varying the size or flow area of the diversion's aperture (orifice) in a manner that would bring about the same result/benefit. An example of such a variation for the adjustment of the aperture (orifice) is presented in FIGS. 8A, 8B, 9A & 9B showing the use of adjustment by linear means and swappable orifice plates, respectively, instead of adjustment by rotary means as is detailed by this overall patent application.

Thus the scope of the invention should be determined by the appended claims and their legal equivalents, and not by the examples given.

What is claimed is: Stormwater diversion apparatus comprising:

1. A system for the diversion or splitting of stormwater at the conveyance structure in order to convey an amount of flow, large or small, into any approved best management practice facility, comprising an adjustment feature that allows for the fine-tuned manipulation of the flow area of an aperture (orifice), in a way which each transition in flow area equates to a pre-measured, lab-tested, flow rate, based on the depth of the structure the apparatus being placed in, until a spillover threshold is met.

2. The diversion of claim 1 wherein said adjustment feature is made meaningful be a gauging mechanism that displays a direct relationship of aperture (orifice) area to a pre-tested flow rate for any given aperture (orifice) setting, whereby allowing the user/installer to calibrate the desired flow rate required for diversion in the field.

3. The diversion system of claim 1 wherein the device shall be produced with the capability to lock in the setting so that the required flow rate will be preserved and protected from illicit manipulation after the unit has being adjusted in the field to required setting.

4. The device will be installed in a pre-selected structure with a required set height dimension, critical in preserving the lab-tested relationship of aperture (orifice) setting verses flow rate.
